(19) United States
(12) Patent Application Publication
(10) Pub. No.: US 2026/0025458 A1
(43) Pub. Date: Jan. 22, 2026

(54) EVIDENCE RECORDING WITH CRITICAL OFFICER COMMUNICATION

(71) Applicant: MOTOROLA SOLUTIONS, INC., Chicago, IL (US)

(72) Inventors: Sean Regan, Delray Beach, FL (US); Nicole D. Berriz, Davie, FL (US); Daniel Grobe Sachs, Elmhurst, IL (US)

(21) Appl. No.: 18/775,976

(22) Filed: Jul. 17, 2024

(51) Int. Cl. H04M 3/22; H04N 7/18

(52) U.S. Cl. CPC H04M 3/2281

(57) ABSTRACT

One example includes a radio device including a radio frequency (RF) interface and an electronic processor communicatively connected to the RF interface and a body-worn camera (BWC). The electronic processor is configured to, in response to receiving an indication that the BWC is in the BWC recording state and a recording ID associated with the BWC recording state, initiate a radio recording state to generate a radio audio recording of audio input to and output by the RF interface. In response to receiving an indication that the BWC has terminated the BWC recording state, the electronic processor terminates the radio recording state, receives a digital fingerprint from the BWC that associates and authenticates a BWC recording with the radio device, and transmits the radio audio recording, the recording ID, and the digital fingerprint to an evidence management server as part of an evidence record.

### BACKGROUND

Body worn cameras (BWCs) are often worn by public safety personnel to capture video and/or photographic evidence of the environment surrounding a public safety officer during an incident.

### BRIEF DESCRIPTION OF THE DRAWINGS

FIG. 1 illustrates a communication system, according to some examples.

FIG. 2 illustrates a block diagram of a body-worn camera (BWC), according to some examples.

FIG. 3 illustrates a block diagram of a radio device, according to some examples.

FIG. 4 illustrates a block diagram of an evidence management server, according to some examples.

FIG. 5 illustrates a method for extending evidence recording of an incident using a radio device, according to some examples.

FIG. 6 illustrates a method for collecting and managing evidence related to an incident, according to some examples.

FIG. 7 illustrates a graphical user interface for displaying evidence related to an incident, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

First responders, emergency service personnel, or security officers may wear body-worn cameras (BWCs). BWCs often include a camera and a microphone. The camera captures video or images of the environment surrounding the officers during an incident, for example, the scene of a fire, a vehicle crash, a criminal investigation, etc. The microphone captures audio from the environment. However, even if a BWC includes a microphone, the BWC may not capture communications made by the officer over the officer's radio. For example, if an officer is wearing a headset or earpiece, the BWC does not capture audio received over the headset. Additionally, if the officer is in a noisy environment, the BWC may not clearly capture audio output from the speaker of the officer's radio. As a result, the video evidence of the incident that is captured using the BWC is incomplete because, for example, it lacks audio information that might provide context to the video.

As one example incident, a public safety officer may confront an individual in response to receiving a radio communication from a dispatcher that the individual has been issued an arrest warrant. BWC footage captured by the officer's BWC may show the officer confronting the individual to make an arrest, but if the environment is noisy or if the officer is using a headset to communicate with the dispatcher, the audio captured by the BWC may fail to provide the context that led to the arrest.

Thus, there is a need for a system and method to securely provide contextual data to BWC footage for evidence collection. One example provides a radio device including a radio frequency (RF) interface configured to transmit and receive audio signals over a RF network; and an electronic processor communicatively connected to the RF interface and a body-worn camera (BWC), the electronic processor configured to receive, from the BWC, an indication that the BWC is in a BWC recording state and a recording identifier (ID) associated with the BWC recording state, in response to receiving the indication that the BWC is in the BWC recording state, enter a radio recording state to generate a radio audio recording of audio input to and output by the RF interface, receive an indication that the BWC has terminated the BWC recording state, in response to receiving the indication that the BWC has terminated the BWC recording state, terminate the radio recording state, receive a digital fingerprint from the BWC that associates and authenticates a BWC recording with the radio device, transmit the radio audio recording, the recording ID, and the digital fingerprint to an evidence management server as part of an evidence record.

In some aspects, the electronic processor is further configured to: generate a timestamp associated with a start time of the radio audio recording, and transmit the timestamp to the evidence management server as part of the evidence record.

In some aspects, the electronic processor is further configured to: in response to receiving the indication that the BWC is in the BWC recording state, acquire metadata associated with operation of the radio device during the radio recording state, the metadata including at least one selected from the group consisting of a channel of the radio device, a zone of the radio device, a battery state of charge of the radio device, an output volume of the radio device, a location of the radio device, a sensor connection state of the radio device, a change of channel of the radio device, a change in output volume of the radio device, an ambient noise level, and an identification of an officer associated with the radio device, acquire a timestamp associated with the metadata, and transmit the metadata and the timestamp to the evidence management server as part of the evidence record.

In some aspects, the electronic processor is configured to transmit a first portion of the metadata to the evidence management server in a first transmission and second portion of the metadata in a second transmission before termination of the radio recording state.

In some aspects, the electronic processor is further configured to digitally sign the transmission to the server.

In some aspects, the radio audio recording includes a first audio track associated with audio inputs to the RF interface and a second audio track record associated with audio outputs of the RF interface.

In some aspects, the radio device further includes a display, wherein the electronic processor is further configured to, in response to entering the radio recording state, provide an indication to the display that the radio device is in the radio recording state.

In some aspects, the electronic processor is communicatively connected to the evidence management server over a broadband network.

In some aspects, the electronic processor is communicatively connected to the BWC over a Bluetooth connection.

Another example provides a server including an electronic processor communicatively connected to a memory, a body-worn camera (BWC), a radio device, and a user interface device, the electronic processor configured to: receive, from the BWC, an indication that the BWC is in a BWC recording state, receive, from the BWC, a BWC recording associated with an incident, the BWC recording including a BWC video data and BWC audio data, in response to receiving the BWC recording, access an evidence record associated with the BWC recording state, the evidence record being stored in the memory, receive, from the radio device, a radio audio recording associated with the incident, a recording ID associated with the radio audio recording, a digital fingerprint that associates and authenticates the BWC recording with the radio device, and a timestamp of the radio audio recording, store the BWC recording, radio audio recording, the recording ID, and the digital fingerprint to the evidence record, generate a multimedia file having a video track of the BWC video data and an audio track of the radio audio recording, wherein the radio audio recording is synced with the BWC video data using the timestamp of the radio audio recording, and output the multimedia file to the user interface device.

In some aspects, the electronic processor is further configured to receive, from the radio device, metadata associated with operation of the radio device during a radio audio recording state, the metadata including at least one selected from the group consisting of a channel of the radio device, a zone of the radio device, a battery state of charge of the radio device, an output volume of the radio device, a location of the radio device, a sensor connection state of the radio device, a change of channel of the radio device, a change in output volume of the radio device, an ambient noise level, and an identification of an officer associated with the radio device, receive a timestamp associated with the metadata, and store the metadata and the timestamp associated with the metadata as part of the evidence record.

In some aspects, the electronic processor is further configured to include the metadata as text data in the multimedia file, the metadata being synced with the BWC video data and the radio audio recording using the timestamp associated with the metadata.

In some aspects, the BWC recording includes BWC audio data, the audio track includes a first audio track and a second audio track, the radio audio recording is included in the first audio track, and the BWC audio data is included in the second audio track.

In some aspects, the electronic processor is further configured to receive, via the user interface device, a user selection of the first audio track and/or the second audio track, and selectively output, using the user interface device, the first audio track and/or the second audio track according to the user selection.

In some aspects, the electronic processor is further configured to receive, via the user interface device, a user input requesting a volume adjustment of a selected one of the first audio track or the second audio track, and output, using the user interface device, the first audio track and the second audio track at respective volumes according to the user input.

In some aspects, the electronic processor is configured to receive audio inputs to the radio device and audio outputs of the radio device as part of the radio audio recording, and the audio track of the multimedia file includes a first audio track of the audio inputs to the radio device and a second audio track of the audio outputs of the radio device.

In some aspects, the electronic processor is further configured to receive, via the user interface device, a user selection of the first audio track and/or the second audio track, and selectively output, using the user interface device, the first audio track and/or the second audio track according to the user selection.

In some aspects, the electronic processor is further configured to receive, from a communication device different from the BWC and the radio device, a related file associated with the incident, store the related file to the evidence record, and display contents of the related file using the user interface device in response to receiving user input requesting to view the related file.

In some aspects, the electronic processor is further configured to receive a digital signature from the radio device authenticating contents of the evidence record.

Another example provides a system including a server including a server electronic processor communicatively connected to a body-worn camera (BWC); and a radio device including a radio frequency (RF) interface and a radio electronic processor communicatively connected to the BWC and the server, the radio electronic processor configured to receive, from the BWC, an indication that the BWC is in a BWC recording state, in response to receiving the indication that the BWC is in the BWC recording state, initiate a radio recording state to generate a radio audio recording of audio input to and output by the RF interface, in response to receiving the indication that the BWC has terminated the BWC recording state, terminate the radio recording state, receive a digital fingerprint from the BWC that associates and authenticates a BWC recording of the BWC with the radio device, transmit the radio audio recording and the digital fingerprint to the server as part of an evidence record of an incident; wherein the server electronic processor is configured to receive, from the BWC, the BWC recording including a BWC video data and BWC audio data, receive, from the radio device electronic processor, the radio audio recording associated with the incident and the digital fingerprint, validate an authenticity of the BWC recording and the radio audio recording using the digital fingerprint, store the radio audio recording, the BWC recording, and the digital fingerprint to the evidence record.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to an electronic processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

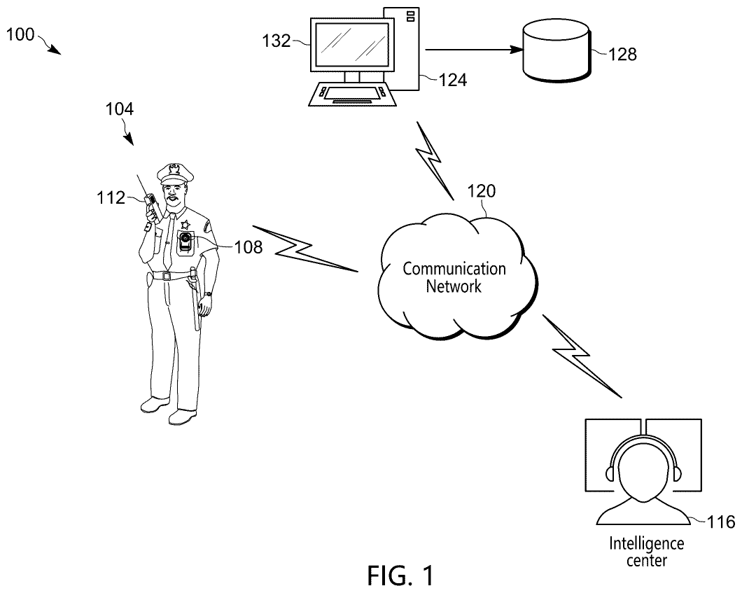

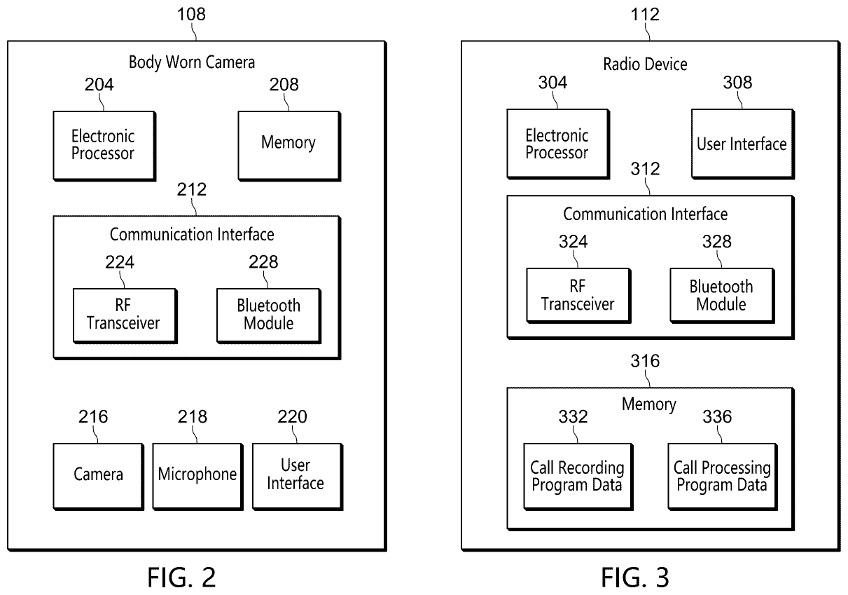

Referring now to the drawings, FIG. 1 illustrates a system 100 for collection and management of evidence related to an incident to which a public safety officer 104 responds. Evidence related to the incident may be collected using one or more sensors. For example, the public safety officer 104 may wear a BWC 108, described in greater detail below with respect to FIG. 2, that records footage of the environment surrounding the public safety officer 104 (e.g., in response to the public safety officer 104 pressing a button or other trigger to initiate recording). The public safety officer 104 may also carry, wear, or otherwise be associated with a radio device 112, described in greater detail below with respect to FIG. 3, for communicating with an intelligence center 116 or another public safety officer. The intelligence center 116 is, for example, a control point for coordinating an incident response (e.g., a real time crime center (RTCC), a dispatch center, a campus security center, or the like).

The public safety officer 104 may otherwise be referred to herein as a first responder 104 or officer 104. The first responder 104 communicates with the intelligence center 116 using the radio device 112 over one or more communications networks 120 (otherwise referred to herein as the communication network 120). The communication network 120 may include, for example, a land mobile radio (LMR) network, a broadband network, a WiFi network, and/or other networks. For example, the radio device 112 may operate according to one or more of a variety of different communication protocols, for example, the Project 25 (P25) standard defined by the Association of Public Safety Communications Officials International (APCO), the TETRA standard defined by the European Telecommunication Standards Institute (ETSI), the Digital Private Mobile Radio (dPMR) standard also defined by the ETSI, the Digital Mobile Radio (DMR) standard also defined by the ESI, a long term evolution (LTE) protocol, LTE-Advanced or LTE-Advanced Pro compliant with, for example, the 3GPP TS 36 specification series, or the 5G (including a network architecture compliant with, for example, the 3GPP TS 23 specification series and a new radio (NR) air interface compliant with the 3GPP TS 38 specification series) standard, or a combination thereof, among other possibilities. In some instances, the BWC 108 is also communicatively connected to the intelligence center 116 via the communication network 120 to transmit BWC footage and/or state information (e.g., recording state, battery state, etc.) to the intelligence center 116.

The radio device 112 and the BWC 108 are also communicatively connected, over the communication network 120, to an evidence management server 124 to transmit recorded audio and video data, along with metadata associated with the audio and video data, to the evidence management server 124. The evidence management server 124 may be associated with and communicatively connected to an evidence management database 128 and a user interface device 132. The BWC 108, the radio device 112, the intelligence center 116, the evidence management server 124, and/or other components of the system 100 may have a continuous or intermittent (e.g., periodic) communicative connection with one another over the communication network 120.

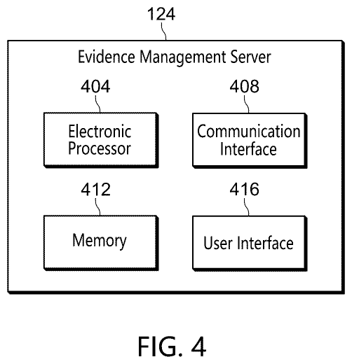

The evidence management server 124, otherwise referred to herein as the server 124, may be located on-premises of or remote from the intelligence center 116. In some instances, the evidence management server 124 is implemented in a distributed manner (e.g., portions of the server logic or server functions may be implemented on multiple devices or electronic processors in the cloud or locally). The evidence management server 124 is described in greater detail below with respect to FIG. 4. The system 100 may include more or fewer components than those illustrates in FIG. 1 and may perform additional functions other than those described herein.

FIG. 2 illustrates a simplified block diagram of the BWC 108. In the example shown, the BWC 108 includes a BWC electronic processor 204 (e.g., one or more BWC electronic processors 204) communicatively connected to a BWC memory 208, a BWC communication interface 212, a camera 216, an optional microphone 218, and a BWC user interface 220. The BWC 108 may include more or fewer components than those illustrates in FIG. 2. The BWC communication interface 212 may communicatively connect the BWC 108 to one or both of the intelligence center 116 and the evidence management server 124 over the communication network 120, for example, using a radio frequency (RF) transceivers 224. The BWC may include more than one RF transceiver 224 and the RF transceiver 224 may include an LMR transceiver, a broadband transceiver, and/or the like. The BWC communication interface 212 also includes a Bluetooth module 232 for short-range communication with other devices, for example, the radio device 112. In some instances, the BWC communication interface 212 communicates with the radio device 112 using other short range communication means (e.g., WiFi, ultra-wideband (UWB), and/or the like). The short-range communication between the BWC 108 and the radio device 112 may be performed using one or more application programming interfaces (APIs) (e.g., a remote procedure call (RPC) API).

The communication interface 212 may implement more or fewer communication protocols than those described with respect to FIG. 2. For example, the BWC communication interface 212 may include a wired communication interface for wired communication with the radio device 112, the intelligence center 116, the evidence management server 124, and/or the user interface device 132.

The camera 216 includes one or more image sensors for capturing image and video data of the environment surrounding the first responder 104 that wears the BWC 108. In some instances, the camera 216 also includes the microphone 218 for recording audio of the environment surrounding the first responder 104. The BWC electronic processor 204 may activate a recording state of the camera 216 based on user input received from the BWC user interface 220. For example, the BWC user interface 228 may include a push button, a switch, or the like for initiating and/or terminating a BWC recording state of the camera 216. The BWC user interface 220 may also include, among other things, an indicator (e.g., an LED indicator or the like) that indicates whether the camera 216 is in a recording state.

The BWC memory 208 stores information related to operation of the BWC 108, such as program instructions that, when executed by the BWC electronic processor 204, cause the BWC electronic processor 204 to perform, among other things, methods described herein. The BWC memory 208 may further store BWC metadata related to operation of the BWC 108. BWC metadata may include, for example, a BWC recording state of the camera 216, a timestamp associated with a start time of the BWC recording state, a state of charge of the BWC 108, a signal strength received by the communication interface 212, and/or the like.

FIG. 3 illustrates a simplified block diagram of the radio device 112. The radio device 112 includes a radio electronic processor 304 (e.g., one or more radio electronic processor 304) communicatively connected to a radio user interface 308, a radio communication interface 312, and a radio memory 316. The radio device 112 may include more or fewer components than those illustrates in FIG. 3. The radio communication interface 312 communicatively connects the radio device 112 to the intelligence center 116 and the server 124 over the communication network 120 (e.g., using one or more RF transceivers 324). Accordingly, the RF transceiver 324 may include an LMR transceiver, a broadband transceiver, and/or the like. The RF transceiver 324 may otherwise be referred to herein as an RF communication interface 324.

The radio communication interface 312 also includes a Bluetooth module 328 or other short range communication module for short-range communication with the BWC 108. The radio communication interface 312 may also include other suitable wired or wireless communication interfaces than those described with respect to FIG. 3.

The RF transceiver 324 receives and transmits audio signals over the communication network 120. For example, the radio user interface 308 may include one or more audio input interfaces (e.g., microphones) and one or more audio output interfaces (e.g., speakers, earpieces, headsets, or the like) for receiving and outputting audio data. In some instances, the audio input interface and/or audio output interface are wirelessly connected to the radio electronic processor 304 via the radio communication interface 312.

The radio electronic processor 304 may also receive sensor data from one or more sensors (e.g., a gun draw sensor, a taser deploy sensor, etc.) associated with the first responder 104 via the radio communication interface 312.

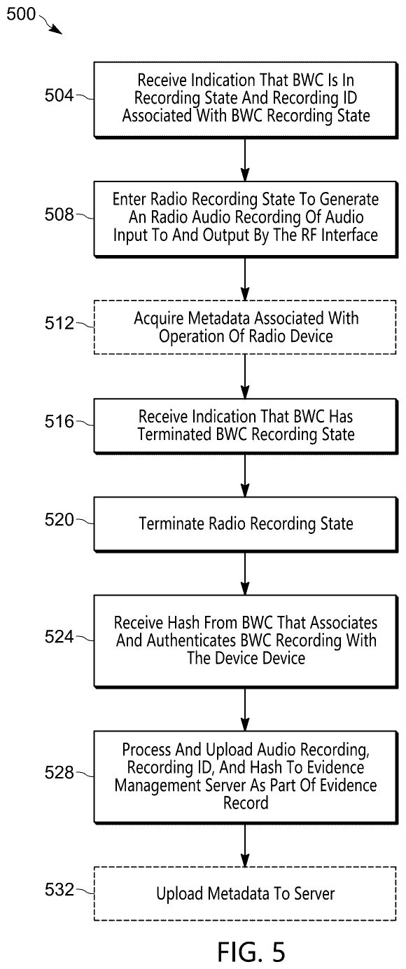

The radio memory 316 stores information related to operation of the radio device 112, such as program instructions that, when executed by the radio electronic processor 304, cause the radio electronic processor 304 to perform, among other things, methods described herein. For example, the radio memory 316 may store call recording program data 332 for recording radio communication between the first responder 104 and the intelligence center 116 or other officers during an incident, and call processing program data for processing the recorded calls. The radio memory 316 may further store radio metadata related to operation of the radio device 112, described in greater detail below with respect to FIG. 5.

FIG. 4 illustrates a simplified block diagram of the evidence management server 124. The evidence management server 124 includes, among other things, a server electronic processor 404 communicatively connected to a server communication interface 408, a server memory 412, and a server user interface 416. The server electronic processor 404 communicates with the user interface device 132, the evidence management database 128, the radio device 112, the BWC 108, and the intelligence center 116 using the server communication interface 408 over the communication network 120. The server memory 412 stores program instructions that, when executed by the server electronic processor 404, cause the server electronic processor 404 to perform, among other things, methods described herein.

FIG. 5 is a flowchart illustrating a method 500 for improved evidence collection implemented by, for example, the radio device 112 (e.g., using the radio electronic processor 304 in conjunction with other components of the radio device 112). In the example shown, the method 500 includes receiving, for example via the Bluetooth module 328, an indication that the BWC 108 is in a BWC recording state and receiving a recording identifier (ID) associated with the BWC recording state (at block 504). For example, the BWC electronic processor 204 transmits the indication that the BWC 108 is in the BWC recording state in response to detecting a trigger through the BWC user interface 220 to start recording the environment surrounding the officer 104. The officer 104 may trigger the BWC 108 to enter the recording state when responding to a public safety incident or the like. The recording ID is, for example, a unique ID (e.g., an alphanumeric identifier or the like) generated by the BWC electronic processor 204 in response to entering the BWC recording state.

In response to receiving the indication that the BWC 108 is in the BWC recording state, the radio electronic processor 304 initiates a radio recording state to generate a recording of audio input to and output by the radio communication interface 312 (e.g., using one or more components of the radio user interface 308) (at block 508). For example, the radio electronic processor 304 records the radio audio using the call recording program data 332. The radio electronic processor 304 may temporarily store the radio audio recorded during the radio recording state in the radio memory 316 and later process the radio audio recording using the call processing program data 336. In some instances, during the radio audio recording state, the radio electronic processor 304 transmits the radio audio recording to the evidence management server 124 before a termination of the radio recording state (e.g., in near-realtime).

In some instances, initiating the radio recording state includes generating a recording timestamp associated with a start time of the radio recording state. For example, the radio electronic processor 304 and the BWC electronic processor 204 may locally sync their respective timestamps with each other using a simple network time protocol (SNTP) such that a start time of the radio audio recording generated by the radio electronic processor 304 matches a start time of the BWC recording generated by the BWC electronic processor 204. Accordingly, generating a recording timestamp using the radio electronic processor 304 may include requesting a SNTP timestamp from the BWC electronic processor 204.

In some instances, initiating the radio recording state further includes providing an indication on a display of the radio device 112 that the radio device 112 is in the recording state. For example, the radio electronic processor 304 may alert the officer 104 that the radio device 112 is recording radio communications by providing the indication on a display screen of the radio device 112, by illuminating an LED indicator on the radio device 112, or by generating an auditory alert through a speaker of the radio device 112.

In some instances, the method 500 includes acquiring, with the radio electronic processor, metadata associated with operation of the radio device 112 during the radio recording state (at block 512). The metadata may include, for example, a channel of the radio device 112, a zone of the radio device 112, a battery state of charge of the radio device 112, an output volume of the radio device 112, a location of the radio device 112 (e.g., determined using a location sensor), a sensor connection state of the radio device, sensor data received from sensors associated with the officer 104, a change of channel of the radio device 112, a change in output volume of the radio device 112, an ambient noise level, and an identification of the officer 104 associated with the radio device 112, or the like. The radio electronic processor 304 may also acquire metadata timestamps associated with respective pieces of metadata or changes in the metadata.

The radio electronic processor 304 may transmit portions of the metadata to the evidence management server 124 at periodic intervals, in near-realtime as the metadata is acquired or in response to changes in the metadata, and/or in response to a termination of the radio recording state. However, in some instances, some or all of the metadata is transmitted after termination of the radio recording state. When transmitted (e.g., uploaded) to the evidence management server 124 as part of, for example, an evidence record, this metadata provides additional context to an incident recorded by the BWC 108. For example, the metadata may indicate that, although the radio device 112 was receiving communication from a dispatcher or other officer during the incident, an output volume setting of the radio device 112 was too low or an ambient noise level was too high for the officer 104 to hear the communications.

The method 500 includes receiving, with the radio electronic processor 304 via the Bluetooth module 328, an indication that the BWC 108 has terminated the BWC recording state (at block 516). For example, the BWC electronic processor 204 transmits the indication that the BWC 108 has terminated the BWC recording state in response to detecting a trigger through the BWC user interface 220 to stop recording the environment surrounding the officer 104. The officer 104 may trigger the BWC 108 to terminate the recording state upon, for example, resolution of the incident.

In response to receiving the indication that the BWC 108 has terminated the BWC recording state, the radio electronic processor 304 terminates the radio recording state (at block 520).

The radio electronic processor 304 also receives a digital fingerprint from the BWC 108 that associates and authenticates the BWC recording with the radio device 112 (at block 524). For example, in response to terminating the BWC recording state, the BWC electronic processor 304 generates a digital fingerprint of a BWC recording generated during the BWC recording state. The digital fingerprint may include a summary hash of the BWC recording, such as a SHA256 hash or the like. The BWC electronic processor 204 transmits the BWC recording and the digital fingerprint to the evidence management server 124 for inclusion in an evidence record associated with the incident. The BWC electronic also processor 204 provides this digital fingerprint to the radio device 112 so that the radio device 112 has a validated reference to the BWC recording. The digital fingerprint and the recording ID shared between the radio electronic processor 304 and the BWC electronic processor 204 therefore link the radio audio recording to the BWC recording, and implement a chain of custody for validating the authenticity of recorded evidence. The shared SNTP timestamp may similarly link the radio audio recording to the BWC recording.

In response to terminating the radio recording state, the radio electronic processor 304 processes and transmits the radio audio recording, the recording ID (e.g., the recoding ID received at block 504), and the digital fingerprint to the evidence management server 124 as part of an evidence record (at block 528). For example, the radio electronic processor 304 may compress and process the radio audio recording to a multi-track audio file (e.g., a multi-track MP4 audio file). In some instances, a first track of the multi-track audio file includes the radio audio inputs to the radio communication interface 312 and a second track of the multi-track audio file includes the radio audio outputs of the radio communication interface 312.

The radio electronic processor 304 may also transmit any metadata related to the operation of the radio device 112 during the radio recording state (e.g., the metadata acquired at block 512) (at block 532). In some instances, the metadata is processed and included as part of the audio file transmission of block 528.

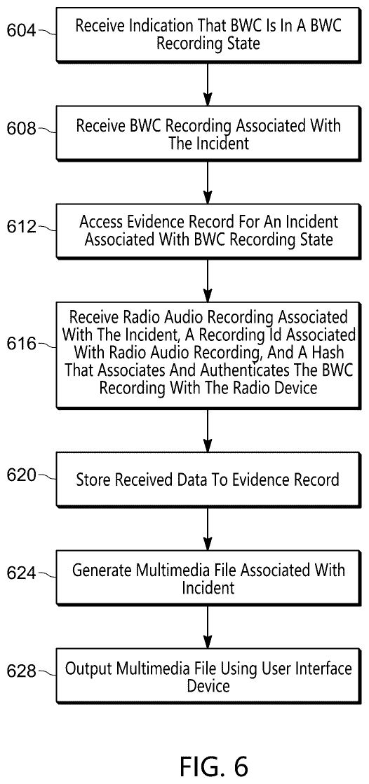

FIG. 6 is a flowchart illustrating a method 600 for improved evidence collection implemented by, for example, the evidence management server 124 (e.g., using the server electronic processor 404 in conjunction with other components of the evidence management server 124). In the example shown, the method 600 includes receiving, from the BWC 108 over the communication network 120, an indication that the BWC is in a BWC recording state (at block 604). The server electronic processor 404 may also receive, from the BWC 108, the recording ID associated with the BWC recording state.

In some instances, the server electronic processor 404 also receives an indication that the radio device 112 is in the radio recording state. In some instances, as described above, the server electronic processor 404 also receives metadata or other recorded data from the radio device 112 and/or the BWC 108 during the radio recording state and BWC recording state. In such instances, the server electronic processor 404 includes this data in the evidence record.

In response to the BWC 108 terminating the BWC recording state, the server electronic processor 404 receives, from the BWC 108, a BWC recording of the incident generated by the BWC 108 (at block 608). In some instances, the server electronic processor 404 also receives a digital fingerprint of the BWC recording generated by the BWC electronic processor 204.

In response to receiving the BWC recording, the server electronic processor 404 generates or otherwise accesses an evidence record associated with the BWC recording (e.g., associated with the incident recorded using the BWC 108) (at block 612). For example, the evidence record may be a pre-existing evidence record to which the server electronic processor 404 adds additional data, or may be a new evidence record created by the server electronic processor 404. The server electronic processor 404 stores the evidence record in, for example, the evidence management database 128.

The server electronic processor 404 also receives, from the radio device 112, the radio audio recording associated with the incident and generated by the radio electronic processor 304, the recording ID associated with the radio audio recording (e.g., the recording ID generated by the BWC electronic processor 204 and shared with the radio electronic processor 304), the digital fingerprint (e.g., the digital fingerprint generated by the BWC electronic processor 204 and shared with the radio electronic processor 304), and the timestamp of the radio audio recording (at block 616). In some instances, the server electronic processor 404 generates the evidence record in response to receiving both the BWC recording and the evidence transmission from the radio device 112.

The server electronic processor 404 uses the digital fingerprint and the recording ID to associate and authenticate the BWC recording received from the BWC 108 with the radio audio recording received from the radio device 112. However, in some instances, the server electronic processor 404 also receives a digital signature from the radio device 112 that adds an additional layer of security by further authenticating the data received from the radio device 112.

The server electronic processor 404 may also receive metadata associated with operation of the radio device 112 and/or the BWC 108 during the respective radio recording state or BWC recording state and/or after termination of the respective radio recording state or BWC recording state.

The server electronic processor 404 stores the data received from the BWC 108 and the radio device 112 (e.g., the radio audio recording, the BWC recording, the recording ID, the digital fingerprint, the timestamps, the metadata, and/or the like) to the evidence record in the evidence management database 128 (at block 620). The server electronic processor 404 may also store an indication of validation (e.g., chain of custody information) of the BWC recording and the radio audio recording.

In some instances, the server electronic processor 404 also stores additional data to the evidence record related to the incident to the evidence record such as, for example, arrest warrants, search warrants, computed aided dispatch (CAD) reports, references to related evidence records, or other files related to the incident.

Using the received data, the server electronic processor 404 generates a multimedia file having a video track of the BWC recording video data and an audio track of the of the radio audio recording, the radio audio recording being synced with the BWC recording video data using the shared timestamp (at block 624). The server electronic processor 404 therefore creates an audio-visual evidence file that provides significantly more situational context than is conventionally provided by BWCs.

In some instances, the server electronic processor 404 generates the multimedia file such that the multimedia file includes multiple audio tracks. For example, the multimedia file may include a first audio track that is audio data from the BWC recording (e.g., recorded by the BWC 108) and a second audio track that includes the radio audio data recorded by the radio device 112. As described above, in some instances, the radio device 112 generates and transmits to the server 124 a first audio track of audio inputs to the radio device 112 and a second audio track that is audio outputs from the radio device 112. In such instances, the multimedia file generated by the server electronic processor 404 may include a first audio track of audio data from the BWC recording, a second audio track of audio inputs to the radio device 112, and a third audio track of audio outputs from the radio device 112.

In some instances, the server electronic processor 404 includes some or all the metadata received from the BWC 108 and/or the radio device 112 as, for example, text data or another format of data in the multimedia file (e.g., as metadata to the multimedia file, as annotations to the multimedia file, etc.). For example, the server electronic processor 404 may generate a timeline or transcript using the metadata and corresponding metadata timestamps, and include the timeline or transcript in the multimedia file. The metadata may be synced with the BWC video data and the radio audio recording using the metadata timestamps.

The server electronic processor 404 may generate a graphical user interface (GUI) to output the contents of the multimedia file using, for example, the user interface device 132 (at block 628). The server electronic processor 404 may provide the GUI to the user interface device 132 using one or more APIs. For example, the user interface device 132 may have a suitable application installed thereon for receiving and rendering user interface data from the server electronic processor 404.

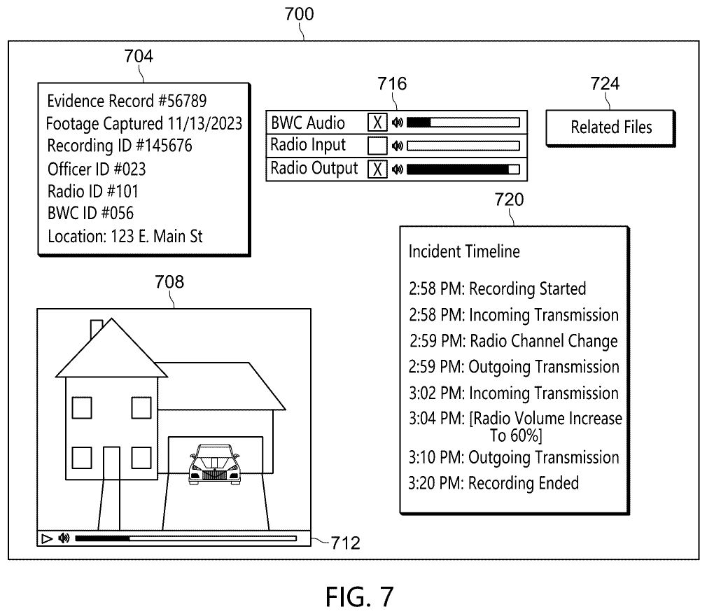

FIG. 7 illustrates an example GUI 700 that the server electronic processor 404 may generated and provide to the user interface device 132 using the multimedia file. In the example of FIG. 7, the GUI 700 may include summary data 704 associated with the incident and aggregated by the server electronic processor 404 using the metadata received from the radio device 112 and/or the BWC 108. The summary data may include, for example, an evidence record or file number, a date associated with the evidence record (e.g., an evidence record created date, the recording ID associated with the BWC recording, an evidence record updated date, a BWC footage recording date, and/or the like), a name and/or ID of the officer 104 responding to the incident, a radio ID of the radio device 112, a BWC ID of the BWC 108, a location of the incident, and/or the like.

The GUI 700 includes a BWC recording playback portion 708 for outputting the video data of the multimedia file, and a playback controller portion 712 for controlling a playback of the video data and any corresponding audio data.

The GUI 700 may also include an audio selection portion 716 for receiving a user selection of one or more audio tracks to include in the BWC recording playback and an output volume adjustment of selected audio tracks. For example, the server electronic processor 404 may selectively output, using the user interface device 132, only BWC audio data and radio recording outputs in response to receiving a user selection of the BWC audio data and radio recording outputs through the user interface device 132. The server electronic processor 404 may also control an output volume of each respective audio track according to user selection received through the user interface device 132. For example, the server electronic processor 404 may output the radio recording outputs at a higher volume than the BWC audio. In this manner, the server electronic processor 404 may reduce an ambient noise level in the BWC recording playback.

The GUI 700 may also include an incident timeline portion 720 having a timeline of metadata events during the BWC and radio recording states. The timeline portion 720 may include indications of when metadata events and metadata changes occur. The illustrated example includes a recording start time, incoming radio transmission times, radio channel changes, radio volume changes, and a recording ending time. However, the timeline portion 720 may include more or fewer metadata events than those illustrated in the example of FIG. 7.

In some instances, server electronic processor 404 generates a transcript of the radio audio recording, and includes the transcriptions of radio inputs and outputs in the timeline portion 720.

The GUI 700 may include a related files portion 724 for receiving user selection to view, download, or otherwise access files related to the incident, such as arrest warrants, search warrants, CAD reports, references to related evidence records, and/or other files related to the incident.

The GUI 700 of FIG. 7 illustrates only one example of a GUI that may be provided to the user interface device 132 by the server electronic processor 404, which may include more or fewer elements than those illustrated in FIG. 7.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot perform radio communication, record and share audio data, record and share video data, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A radio device comprising:
a radio frequency (RF) interface configured to transmit and receive audio signals over a RF network; and
an electronic processor communicatively connected to the RF interface and a body-worn camera (BWC), the electronic processor configured to
receive, from the BWC, an indication that the BWC is in a BWC recording state and a recording identifier (ID) associated with the BWC recording state,
in response to receiving the indication that the BWC is in the BWC recording state, enter a radio recording state to generate a radio audio recording of audio input to and output by the RF interface,
receive an indication that the BWC has terminated the BWC recording state,
in response to receiving the indication that the BWC has terminated the BWC recording state, terminate the radio recording state,
receive a digital fingerprint from the BWC that associates and authenticates a BWC recording with the radio device,
transmit the radio audio recording, the recording ID, and the digital fingerprint to an evidence management server as part of an evidence record.

2. The radio device of claim 1, wherein the electronic processor is further configured to:
generate a timestamp associated with a start time of the radio audio recording, and
transmit the timestamp to the evidence management server as part of the evidence record.

3. The radio device of claim 1, wherein the electronic processor is further configured to:
in response to receiving the indication that the BWC is in the BWC recording state, acquire metadata associated with operation of the radio device during the radio recording state, the metadata including at least one selected from the group consisting of a channel of the radio device, a zone of the radio device, a battery state of charge of the radio device, an output volume of the radio device, a location of the radio device, a sensor connection state of the radio device, a change of channel of the radio device, a change in output volume of the radio device, an ambient noise level, and an identification of an officer associated with the radio device,
acquire a timestamp associated with the metadata, and
transmit the metadata and the timestamp to the evidence management server as part of the evidence record.

4. The radio device of claim 3, wherein the electronic processor is configured to transmit a first portion of the metadata to the evidence management server in a first transmission and second portion of the metadata in a second transmission before termination of the radio recording state.

5. The radio device of claim 1, wherein the electronic processor is further configured to digitally sign the transmission to the evidence management server.

6. The radio device of claim 1, wherein the radio audio recording includes a first audio track associated with audio inputs to the RF interface and a second audio track record associated with audio outputs of the RF interface.

7. The radio device of claim 1, further comprising:
a display,
wherein the electronic processor is further configured to, in response to entering the radio recording state, provide an indication to the display that the radio device is in the radio recording state.

8. The radio device of claim 1, wherein the electronic processor is communicatively connected to the evidence management server over a broadband network.

9. The radio device of claim 1, wherein the electronic processor is communicatively connected to the BWC over a Bluetooth connection.

10. A server comprising:
an electronic processor communicatively connected to a memory, a body-worn camera (BWC), a radio device, and a user interface device, the electronic processor configured to
receive, from the BWC, an indication that the BWC is in a BWC recording state,
receive, from the BWC, a BWC recording associated with an incident, the BWC recording including a BWC video data and BWC audio data,
in response to receiving the BWC recording, access an evidence record associated with the BWC recording state, the evidence record being stored in the memory,
receive, from the radio device, a radio audio recording associated with the incident, a recording ID associated with the radio audio recording, a digital fingerprint that associates and authenticates the BWC recording with the radio device, and a timestamp of the radio audio recording,
store the BWC recording, radio audio recording, the recording ID, and the digital fingerprint to the evidence record,
generate a multimedia file having a video track of the BWC video data and an audio track of the radio audio recording, wherein the radio audio recording is synced with the BWC video data using the timestamp of the radio audio recording, and
output the multimedia file to the user interface device.

11. The server of claim 10, wherein the electronic processor is further configured to
receive, from the radio device, metadata associated with operation of the radio device during a radio audio recording state, the metadata including at least one selected from the group consisting of a channel of the radio device, a zone of the radio device, a battery state of charge of the radio device, an output volume of the radio device, a location of the radio device, a sensor connection state of the radio device, a change of channel of the radio device, a change in output volume of the radio device, an ambient noise level, and an identification of an officer associated with the radio device,
receive a timestamp associated with the metadata, and
store the metadata and the timestamp associated with the metadata as part of the evidence record.

12. The server of claim 11, wherein the electronic processor is further configured to include the metadata as text data in the multimedia file, the metadata being synced with the BWC video data and the radio audio recording using the timestamp associated with the metadata.

13. The server of claim 10, wherein
the BWC recording includes BWC audio data,
the audio track includes a first audio track and a second audio track,
the radio audio recording is included in the first audio track, and
the BWC audio data is included in the second audio track.

14. The server of claim 13, wherein the electronic processor is further configured to
receive, via the user interface device, a user selection of the first audio track and/or the second audio track, and
selectively output, using the user interface device, the first audio track and/or the second
audio track according to the user selection.

15. The server of claim 13, wherein the electronic processor is further configured to
receive, via the user interface device, a user input requesting a volume adjustment of a selected one of the first audio track or the second audio track, and
output, using the user interface device, the first audio track and the second audio track at respective volumes according to the user input.

16. The server of claim 10, wherein
the electronic processor is configured to receive audio inputs to the radio device and audio outputs of the radio device as part of the radio audio recording, and
the audio track of the multimedia file includes a first audio track of the audio inputs to the radio device and a second audio track of the audio outputs of the radio device.

17. The server of claim 16, wherein the electronic processor is further configured to
receive, via the user interface device, a user selection of the first audio track and/or the second audio track, and
selectively output, using the user interface device, the first audio track and/or the second audio track according to the user selection.

18. The server of claim 10, wherein the electronic processor is further configured to
receive, from a communication device different from the BWC and the radio device, a related file associated with the incident,
store the related file to the evidence record, and
display contents of the related file using the user interface device in response to receiving user input requesting to view the related file.

19. The server of claim 10, wherein the electronic processor is further configured to receive a digital signature from the radio device authenticating contents of the evidence record.

20. A system comprising:
a server including a server electronic processor communicatively connected to a body-worn camera (BWC); and
a radio device including a radio frequency (RF) interface and a radio device electronic processor communicatively connected to the BWC and the server, the radio electronic processor configured to
receive, from the BWC, an indication that the BWC is in a BWC recording state,
in response to receiving the indication that the BWC is in the BWC recording state, initiate a radio recording state to generate a radio audio recording of audio input to and output by the RF interface,
in response to receiving the indication that the BWC has terminated the BWC recording state, terminate the radio recording state,
receive a digital fingerprint from the BWC that associates and authenticates a BWC recording of the BWC with the radio device,
transmit the radio audio recording and the digital fingerprint to the server as part of an evidence record of an incident;
wherein the server electronic processor is configured to
receive, from the BWC, the BWC recording including a BWC video data and BWC audio data,
receive, from the radio device electronic processor, the radio audio recording associated with the incident and the digital fingerprint,
validate an authenticity of the BWC recording and the radio audio recording using the digital fingerprint,
store the radio audio recording, the BWC recording, and the digital fingerprint to the evidence record.
